(19) United States
(12) Patent Application Publication
(10) Pub. No.: US 2003/0194189 A1
(43) Pub. Date: Oct. 16, 2003

(54) Inspection wand

(76) Inventors: William J. Grothe, Mission Viejo, CA (US); Jianli Ren, Aliso Viejo, CA (US); Paul E. Robbins, Mission Viejo, CA (US); Peter McNicol, Huntington Beach, CA (US); John D. Garman, Costa Mesa, CA (US)

Correspondence Address: Brian F. Drazich, Coudert Brothers LLP, 23rd Floor, 333 South Hope Street, Los Angeles, CA, 90071, US

(21) Appl. No.: 10/414,160

(22) Filed: Apr. 14, 2003

Related U.S. Application Data
(60) Provisional application No. 60/373,006, filed on Apr. 15, 2002.

(51) Int. Cl. F21V 8/00

(52) U.S. Cl. 385/88; 362/577; 385/901

(57) ABSTRACT

The present invention concerns a light wand including a flashlight, a section of light transmitting flexible fiber optic having a plurality of slits along its length, and a tubular coupling adapted to optimize the transmission of light from the flashlight to the fiber optic.

### CROSS REFERENCE TO RELATED APPLICATIONS

This application claims the benefit of U.S. Provisional Application Serial No. 60/373,006, filed Apr. 15, 2002, which is incorporated herein by reference.

### TECHNICAL FIELD

The present invention relates to a hand held polymeric core fiber optic light emitting wand that is particularly adapted for inspection of cavities, dark areas and spaces not conveniently inspected through the use of a conventional flashlight.

### BACKGROUND ART

Flash lights are well-known, and toy type wands used as props in movies such as the “Star Wars” series as weapons are known, and as such, are known to provide a wand in which one end is adapted to be held by a hand and the other end of the wand emits light.

### DISCLOSURE OF INVENTION

The present invention inspection light wand includes a conventional flash light, a flexible, polymeric side emitting fiber optic conduit wand adapted to transmit light radially outward for up to 360° of angle along its length. The fiber optic conduit is coupled to the flash light by an intermediate coupling that includes a light focusing lens placed therein and is sized and adapted to optimize the light transmitted from the flash light into and along the fiber optic section of the wand. A strain relief connection is also provided at the point of attachment of the polymeric fiber optic to the coupling. The distal end of the fiber optic is provided with an opaque end cap, in which a reflector is provided to reflect light transmitted along the interior of the fiber optic conduit backward towards the light source, to facilitate and maximize light transmission radially outward from the wand. Also, preferably and optimally, the fiber optic conduit is of the type in which a polymeric core is surrounded by a clad which in turn is surrounded by a protective finish jacket. Furthermore, it is preferable that slices are provided in the clad core to enhance the amount of light transmitted outward radially from the wand. Although various configurations and sizes and shapes of slits, cuts or slices may be useful within the scope of the present invention, the most preferred embodiment includes a plurality of slits placed along the length of the fiber optic conduit, with four slits placed circumferentially around the clad core with the centers of the slits arranged 90°, or orthogonal, to each other.

### BRIEF DESCRIPTION OF THE DRAWINGS

Detailed drawings of the present invention are shown in the attached Figures, in which:

FIG. 1 is a perspective view of a preferred embodiment of the present invention wand.

FIG. 2 is an exploded view of the FIG. 1 embodiment.

FIG. 3 is a longitudinal cross-sectional view of the coupling of the FIG. 1 embodiment.

FIG. 4 is a transverse cross-sectional view of the FIG. 1 embodiment, taken through line 4-4 of FIG. 3.

FIG. 5 is an end view of the FIG. 3 coupling.

FIG. 6 is a cross-sectional view of the fiber optic conduit of FIG. 1, taken along line 6-6 of FIG. 1.

FIG. 7 is a longitudinal cross-sectional view of a section of the fiber optic conduit of FIG. 1, taken along line 7-7 of FIG. 6.

FIG. 8 is a longitudinal cross-sectional view of an alternate embodiment of a fiber optic conduit of the present invention.

FIG. 9 is a partial cut-away perspective view of a section of the fiber optic conduit of the FIG. 8 embodiment.

FIG. 10 is a perspective view of the FIG. 1 embodiment shown in a particular environment of use.

### BEST MODE FOR CARRYING OUT THE INVENTION

The present invention is directed to a hand held light emitting wand 20 adapted for illuminating dark areas, in particular, areas, volumes, cavities or spaces for which conventional flash lights do not provide optimal lighting. For example, one preferred use of the present invention is for inspection of wheel wells, cargo containers, engine wells and other cavities of vehicles to be inspected on highways, parking lots, garages and the like. Although a polymeric optical wand of the present invention can be provided in various forms, a preferred embodiment of the present invention includes a conventional flash light 22 as a light source, and a predetermined length of a flexible, polymeric light conduit 24 operatively connected to each other through a coupling 26. A strain relief spring connector 28 is provided at the connection of the fiber optic 24 to the coupling 26, to provide strain relief at the concentration of bending forces when the light wand is operated such that the fiber optic portion 24 becomes bent.

Although the present invention may be adapted for use with most any conventional flash light, preferred light sources are those having relatively high intensity light output, and made of a rugged and durable construction so as to be operable in harsh, outdoor environments and heavy use. The preferred light source is a rechargeable Surefire® brand, conventional flashlight commercially available as the Model 8NX Commander. As shown in FIG. 2 the flashlight has a head 30, which is threaded at 32 and contains therein a lamp 34.

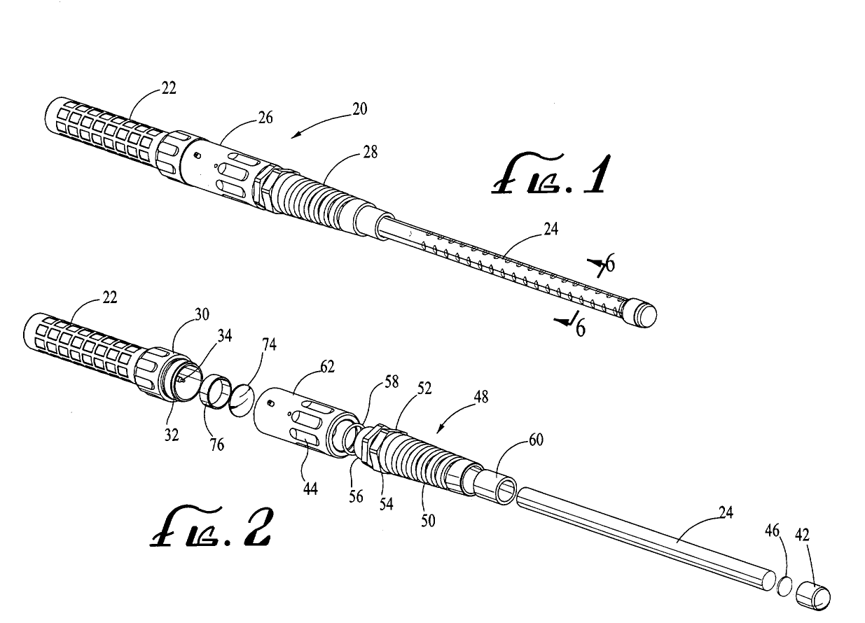

The preferred optical conduit is linear emitting optical fiber manufactured by Lumenyte International Corporation as its LEF™ side lit optical fiber 24, as shown in FIG. 2. Preferred optical conduit are also shown and described in U.S. Pat. Nos. 4,957,347; RE36,157; 5,903,695; 5,937,127; 5,987,199; 6,251,311; 6,282,355 and 6,289,150 which are incorporated herein by reference. The most preferred optical conduit for the present invention is Lumenyte LEF™ polymeric optical conduit further modified to include a plurality of slits, as illustrated in FIGS. 1, 6 and 7, and as will be described in greater detail. The use of flexible, polymeric optical fiber is preferred because it combines several advantageous features, namely, the ability to transmit light efficiently and to bend. This bendability or flexibility feature enhances the usefulness of the wand for inspection of areas behind walls, in cavities such as truck or car wheel wells and the like. While various lengths and diameters of the polymeric optic may be usefully employed in the invention, the preferred polymeric fiber optic has a ½ inch diameter core and employs a length of approximately 1½ feet of fiber optic, with the light transmission enhancing slits placed along a length of about 1-foot. The polymeric fiber optic then, including the approximately 1 foot section with the slits, is approximately 1½ feet in total length. The distal end of the fiber optic is provided with an end cap 42. The end cap 42 is preferably tight fitting and made of a polymeric material that is opaque. End cap 42 is retained on the end of the fiber optic 24 through use of a heat shrink fluoropolymeric jacket 88. Placed inside of the end cap and oriented to reflect light back toward the fiber optic 24 is a reflecting mirror 46. The fluoropolymeric jacket 88 is preferably of a heat shrinkable fluoropolymeric material that has been shrunken down over the end cap and conduit interface to provide a liquid impervious barrier to the inside of the end cap.

At the opposite end of the fiber optic conduit 24 it is shown a spacer 60, which retains the other distal end of the conduit 24, and is contained within a conventional strain relief, spring type retainer 48, showing leaves of the spring at 50 and fastening nuts 52 and 54. Also shown on FIG. 2, is conventional O-ring 58 which is slip fit over the threaded end connection 56 of retainer 48 to provide a seal between the retainer 48 and the coupling 62.

The strain relief 48 is threaded at a conventional end connection 56 and is connected to a coupling 62 by mating with threaded wall 68. The coupling 62 is removably retained to the head of the flashlight 22 with a conventional threaded connection, the threads of the flashlight shown at 32. The coupling 62 is essentially a tube that is sized and configured to provide a chamber and a lens 74 within the chamber together which are adapted to optimize the transmission of light from the flash light lamp 34 to and through the flexible conduit, shown at 24 on FIGS. 1 or 2. The coupling 62 may be made of a durable hard plastic material, or, may also be made of metal. As shown in FIG. 2, a plurality of scallops or shallow recesses 44 are formed in the periphery of the coupling 62 to function as a hand grip and facilitate rotating the coupling during assembly or disassembly of the wand 20.

Referring to FIG. 3, the coupling 62 is shown with a first end 64 having a bore and a threaded interior wall at 68 for connection to the strain relief 48. Orifice 72 provides for a path of light from lens 74 through which light is focused on to the fiber optic conduit. The lens is held in place by retaining ring 76 at one end and at the opposite end lens 74 butts up against a shoulder formed in the wall of the coupling 62 at the intersection of differently diametered bores as shown in FIG. 3. The retaining ring is removably fastened in place through use of two set screws that are screwed into the threaded bores 80 and 82 as shown in FIGS. 3 and 5, with the bores 80 and 82 orthogonal to each other. The setscrews are conventional set screws and not shown in these figures. The second end 66 of the coupling 62 includes a chamber 78 and a larger diameter, threaded bore 70, into which the head of the flashlight is screwed at threads 32.

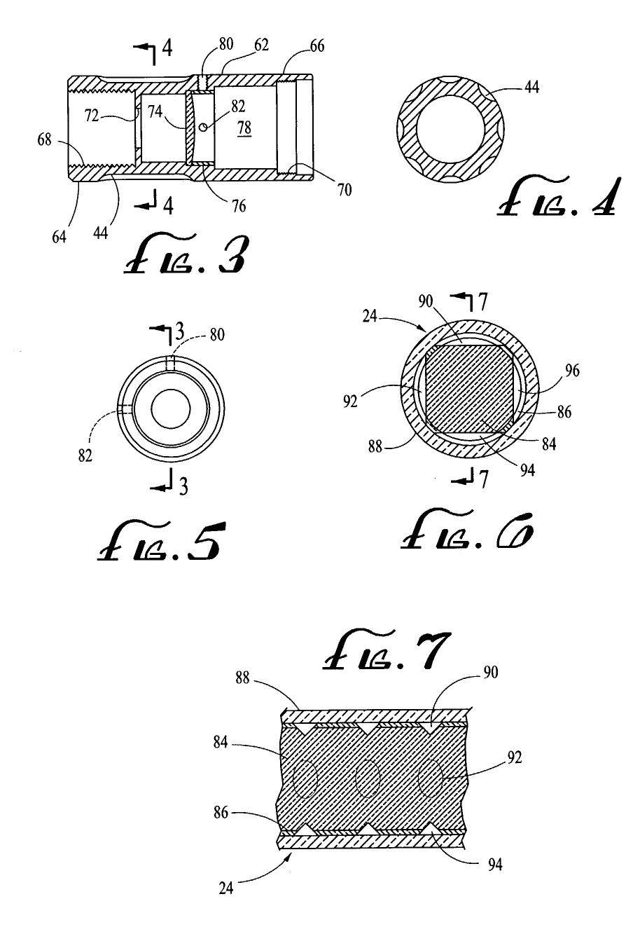

FIG. 4 is a cross-sectional view of the coupling of line 4-4 of FIG. 3 and illustrates a plurality of the slots or channels 44, only one of which is numbered. The number, configuration, length and depth of the channels or scalloped out areas 44 may be varied in accordance with the end use or characteristics desired by the user.

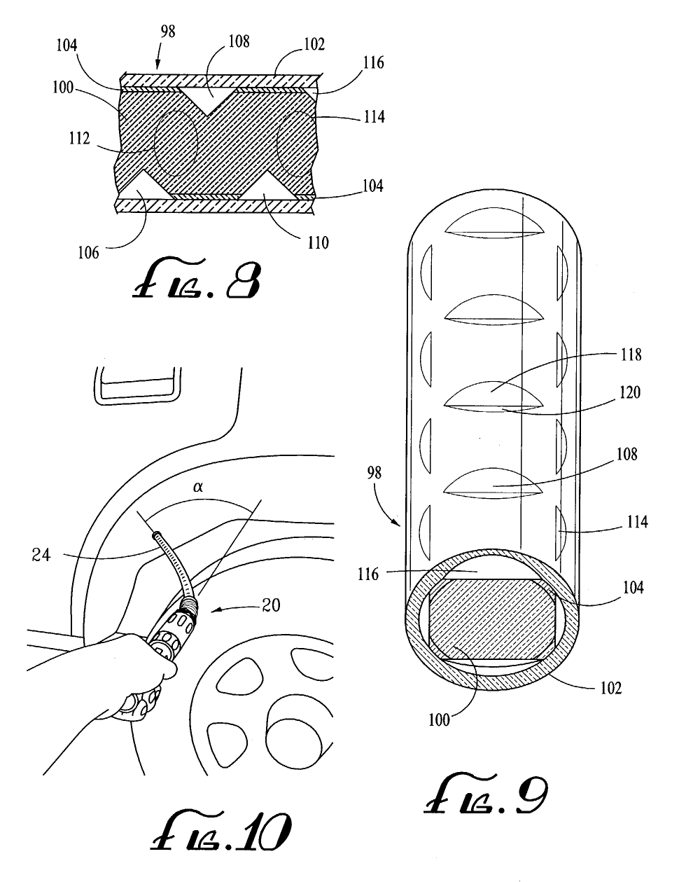

With reference to FIGS. 1, 6 and 7, the structure of the section of the wand that emits light will be further described. As shown in FIG. 1, a predetermined length, preferably about 1-foot of the clad core of the fiber optic conduit is provided with a plurality of cuts along the length, and around the radial periphery of the fiber optic. These cuts may be formed in a fashion that is conventional, but the configuration and number of cuts and orientation of the cuts for use in the present invention is novel and considered to be a feature of the present invention. While the number, size, orientation and depth of the cuts may be varied and still be within the scope of the present invention, the present invention may use a fiber optic conduit that has no such cuts. However, the preferred light wand of the present invention uses at least one row of cuts extending along the length of the fiber optic conduit. Most preferably, the present invention employs several rows of cuts along the length of the conduit, and the presently known best mode of carrying out the invention includes a series of cuts extending along a 1-foot length of the fiber optic at four linear locations, i.e., on lines extending longitudinally along the length of the fiber optic at or near the outer periphery of the fiber optic and oriented 90° from each other, as shown in FIGS. 1, 6 and 7. With reference to FIG. 6, the core 84 is surrounded by a conventional, preferably Teflon® brand fluoropolymer (FEP), polymeric cladding 86 which in turn is surrounded by a durable, translucent or transparent, flexible protective finish jacket 88 to provide a liquid impervious barrier to the inside of the fiber optic. With FIG. 6 being a cross-section of the fiber optic core taken along lines 6-6 of FIG. 1, it may be seen that each of four slits 90, 92, 94 and 96 are cut in the fiber optic clad core. As shown in FIG. 6 the four slits or cuts are equal distances from each other and have the same length, cut angle and depth. It has been found that this configuration provides an optimal transmission of light from the wand and outward radially, in a 360° arc, to provide visible light for inspection of cavities, enclosed areas, partially enclosed areas, wheel wells, trunks, engine cavities, cargo containers and other areas or volumes for which inspection without the aid of a flashlight or with the aid of a conventional flashlight does not permit a full and complete inspection. FIG. 7 is a cross-sectional view taken along lines 7-7 of FIG. 6, and shows the orientation of the slits 90, 92, 94 and 96 as also shown in FIG. 6.

FIGS. 8 and 9 show, by way of example, an alternate configuration for the slits used in the present invention. In the alternate embodiment of FIGS. 8 and 9, the slits are placed in a staggered orientation whereby slits on opposite sides of the fiber optic, along its length, are offset from each other. For example the slits 106 and 110, shown in FIG. 8 at the bottom of the conduit, are offset from the slit 108, shown on the top of the conduit in FIG. 8. In the FIG. 8 embodiment, core 100 is surrounded by a cladding 104, which in turn is surrounded by the protective, relatively thick and durable finish jacket 102. Slits 106, 108, 110 and 116 are shown as top and bottom slits in the FIG. 8 view and slits 112 and 114 are shown to be on the side of the conduit and, as shown in FIG. 8, elliptical in its cross-sectional projection. FIG. 9 provides a perspective, partial cut away view of the alternate embodiment conduit, showing the slit 108 as a wedge shaped cut taken out of the clad core. The slits formed in the clad core of the present invention will have two sidewalls, shown as 118 and 120 in FIG. 9. The angle formed by these two sidewalls can vary, within the scope of the present invention. However, it is preferred that an angle of approximately 52° is most preferred in the present invention.

FIG. 10 illustrates an advantageous feature of the present invention. In this use, the wand 20 is shown in use for inspection of a wheel well. The end of the wand has been pressed up against the wheel well so that the flexible fiber optic conduit portion 24 is bent at an angle alpha. Although the angle alpha may vary according to the degree of force applied and length of conduit used, for a 1½ foot total conduit length, a bend angle alpha of about 30 degrees is easily achieved with the present invention.

While the present invention has been described in connection with what is presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

We claim the following:

1. A fiber optic inspection wand comprising:
at least one length of flexible, light transmitting polymeric fiber optic conduit having a proximate end and a distal end;
said conduit including a clad core sheathed by a light transmitting jacket;
a tubular coupling having a first end connected to the light emitting end of a flash light and a second end connected to said proximate end of the conduit.

2. A fiber optic inspection wand comprising:
at least one length of flexible, light transmitting polymeric fiber optic conduit having a proximate end and a distal end;
a tubular coupling having a first end adapted to be connected to a flash light and a second end adapted to be connected to said proximate end of the conduit;
said coupling connected to said flash light and connected to said proximate end of the conduit; and
a light path from said flash light through said coupling into said conduit, whereby light is transmitted along and emitted from said conduit.

3. The fiber optic inspection wand of claims 1 or 2 further including:
a lens positioned within said coupling adapted to refract light emitted by the flash light toward the proximate end of the conduit.

4. The fiber optic inspection wand of claims 1 or 2 further including:
a mirror positioned at the distal end of the conduit adapted to reflect light toward the proximate end of the conduit.

5. The fiber optic inspection wand of claims 1 or 2 further including:
a plurality of slits positioned in the conduit.

6. The fiber optic inspection wand of claims 1 or 2 wherein:
said coupling is removably affixed to said flash light.

7. A fiber optic inspection wand comprising:
a handheld light source adapted to direct light in a defined beam;
a cylindrical polymeric fiber optic conduit having a predetermined length adapted to emit transmitted light radially;
said fiber optic conduit coupled to said handheld light source by a coupling whereby said beam is directed substantially into and along the length of said fiber optic conduit.

8. The fiber optic inspection wand of claim 7 wherein:
said coupling is removably affixed to said handheld light source.

9. A fiber optic inspection wand comprising:
a housing adapted to be manipulated in a human hand;
said housing containing a source of energy and a light source;
said source of energy and said light source being operationally linked whereby the light source emits light;
a coupling affixed to said housing adapted to receive and retain at least one fiber optic conduit of predetermined length;
said at least one fiber optic conduit retained in said coupling disposed such that at least some of the light emitted by the light source is transmitted by said conduit; and
said at least one fiber optic conduit is adapted to emit light substantially radially along at least a portion of its length.

10. The fiber optic inspection wand of claim 9 wherein:
said coupling is removably affixed to said housing.

11. The fiber optic inspection wand of claim 1, claim 2, claim 7 or claim 9 wherein:
said coupling is removably affixed to said fiber optic conduit.

12. The fiber optic inspection wand of claim 1, claim 2, claim 7 or claim 9 wherein:
said length of the fiber optic conduit defines a central longitudinal axis of said conduit; and
said fiber optic conduit is adapted to emit transmitted light outwardly substantially orthogonally to said longitudinal axis.

13. The fiber optic inspection wand of claim 1, claim 2, claim 7 or claim 9 wherein:
said length of the fiber optic conduit defines a central longitudinal axis of said conduit; and
at least one groove formed in said fiber optic conduit adapted to emit transmitted light outwardly in a predetermined range of angles with reference to said longitudinal axis.

14. The fiber optic inspection wand of claim 1, claim 2, claim 7 or claim 9 wherein:
said fiber optic conduit includes a clad polymeric core comprising a light transmitting polymeric core sheathed by a cladding;
said fiber optic conduit includes a first surface extending circumferentially along the length of said clad polymeric core; and
at least one cavity formed in said first surface extending through the cladding and into the polymeric core adapted to project outwardly light transmitted through the interior of the clad core.

15. The fiber optic inspection wand of claim 1, claim 2, claim 7 or claim 9 wherein:
said fiber optic conduit includes a clad polymeric core comprising a light transmitting polymeric core sheathed by a cladding;
said fiber optic conduit includes a first surface extending circumferentially along the length of said clad polymeric core;
at least one cavity formed in said first surface extending through the cladding and into the polymeric core adapted to project outwardly light transmitted through the interior of the clad core; and
a light transmitting plastic jacket sheathing said clad polymeric core.

16. The fiber optic inspection wand of claim 1, claim 2, claim 7 or claim 9 wherein:
said fiber optic conduit includes a clad polymeric core comprising a light transmitting polymeric core sheathed by a cladding;
said clad polymeric core includes a first surface extending circumferentially along the length of said clad polymeric core;
at least one cavity extending from said first surface into the polymeric core adapted to project outwardly light transmitted through the interior of the clad core.

17. The fiber optic inspection wand of claim 1, claim 2, claim 7 or claim 9 wherein:
said fiber optic conduit includes a clad polymeric core comprising a light transmitting polymeric core sheathed by a cladding;
said clad polymeric core includes a first surface extending circumferentially along the length of said clad polymeric core;
at least one cavity extending from said first surface into the polymeric core adapted to project outwardly light transmitted through the interior of the clad core; and
a light transmitting plastic jacket sheathing said clad polymeric core.

18. The fiber optic inspection wand of claim 1, claim 2, claim 7 or claim 9 wherein:
said fiber optic conduit is a flexible conduit including a clad light transmitting polymeric core sheathed by a light transmitting plastic jacket.

19. The fiber optic inspection wand of claim 7 or claim 9 wherein:
at least one lens is disposed within said coupling;
said at least one lens adapted to refract light emitted by the light source toward said conduit.

20. The fiber optic inspection wand of claim 7 or claim 9 wherein:
at least one mirror affixed to said conduit adapted to reflect transmitted light emitted by the light source into said conduit.

21. The fiber optic inspection wand of claim 7 or claim 9 wherein:
said fiber optic conduit includes a clad polymeric core comprising a light transmitting polymeric core sheathed by a cladding; and
at least one notch penetrating said cladding extending into the polymeric core.

22. The fiber optic inspection wand of claim 7 or claim 9 wherein:
said fiber optic conduit includes a clad polymeric core comprising a light transmitting polymeric core sheathed by a cladding;
at least one notch penetrating said cladding extending into the polymeric core; and
a liquid impervious light transmitting plastic jacket surrounding said clad polymeric core.

23. The fiber optic inspection wand of claim 7 or claim 9 wherein:
said fiber optic conduit includes a clad polymeric core comprising a light transmitting polymeric core sheathed by a cladding;
at least one groove penetrating said cladding extending into the polymeric core; and
a liquid impervious light transmitting plastic jacket surrounding said clad polymeric core.
